(19) United States
(12) Patent Application Publication
(10) Pub. No.: US 2013/0290522 A1
(43) Pub. Date: Oct. 31, 2013

(54) Engine, System and Method of Locating a Mobile Device and Reporting on Other Devices Proximately Located Thereto

(71) Applicant: Edward F. Behm, JR., Cherry Hill, NJ (US)

(72) Inventor: Edward F. Behm, JR., Cherry Hill, NJ (US)

(21) Appl. No.: 13/861,042

(22) Filed: Apr. 11, 2013

Related U.S. Application Data
(60) Provisional application No. 61/622,769, filed on Apr. 11, 2012.

(51) Int. Cl. H04L 12/26

(52) U.S. Cl. CPC H04L 43/10
USPC 709/224

(57) ABSTRACT

The present invention provides an engine, system and method for providing a method of locating a mobile device and reporting on other devices proximately located thereto.

### CROSS REFERENCE TO RELATED APPLICATIONS

The present invention claims priority to U.S. Provisional Patent application Ser. No. 61/622,769 entitled Engine, System And Method Of Locating A Mobile Device And Reporting On Other Devices Proximately Located Thereto, filed Apr. 11, 2012, the entirety of which is incorporated by reference herein.

### FIELD OF THE INVENTION

The present invention relates to data normalization in relation to information access and sharing across platforms, and, more particularly, to an engine, system and method of locating a mobile device and reporting on other devices proximately located thereto.

### BACKGROUND OF THE INVENTION

The number of mobile devices held by minors has increased dramatically in the last few years and may allow parents and those who are responsible for the well-being of the minor to keep in constant communication with the minor and to better understand his/her whereabouts. However, such an inquiry may be intrusive and unwanted by the minor, making the information received questionable.

The following references provide background and teachings for the present invention and are incorporated by reference as if set-forth in their entirety herein:

U.S. Pat. No. 7,463,861 and US patent applications 20090093215 and 20060199538 by Eisenbach et al. titled Automatic data encryption and access control based on Bluetooth device proximity teaches a method and apparatus for securing sensitive data on a secured Bluetooth device whereby when contact is lost, sensitive data is automatically encrypted, and when contact is restored, the data is automatically decrypted. Also, US patent application 20090047903 by the same inventor titled Automatic resource availability using Bluetooth teaches a method for designating trusted devices, and designating files as shareable. When in proximity to a trusted device, shareable files may be accessed securely. Similarly, US patent application 20060199536 by the same inventor titled Automatic network and device configuration for handheld devices based on Bluetooth device proximity teaches a method for automatically using the lowest cost connection from the available set of paired devices that are in proximity with the Bluetooth handheld device. These systems do not provide secure automatic login to applications and does not alarm when a mobile device is lost.

U.S. Pat. No. 7,526,295 by Khare et al. titled Integration of secure identification logic into cell phone teaches a method for generating a password based on a seed and synchronization time, and displaying the password on a mobile phone display. The user can use the password to access a network. The current prior art does not disclose a method or apparatus for proximity alarming or automatic login to an application.

U.S. Pat. No. 7,378,939 by Sengupta et al. titled Method and apparatus for providing proximity based authentication, security, and notification in a wireless system teaches a method for automatically locking a mobile device when an authentication device is not within proximity, while keeping the user logged in, wherein a locked device cannot be used by anyone and an unlocked device can be used by the user.

Sengupta invention teaches logging user to the wireless mobile device, i.e. at the operating system level, and not to an application running on said device. Sengupta invention does not teach an API that can integrate automatic login function into an application. It does not send the password to a RADIUS server. Furthermore, Sengupta system does not alarm when the mobile phone is lost or stolen.

U.S. Pat. No. 6,577,239 by Jespersen et al. titled Electronic apparatus including a device for preventing loss or theft also teaches a control device for sending an enabling signal to a mobile phone. The enabling signal enables operation of the mobile phone. If the mobile phone is no longer able to receive the enabling signal, then it is disabled. This patent does not teach a method for automatic login to an application.

U.S. Pat. No. 7,076,238 by Matsumoto et al. titled Wireless communication system exchanging encrypted data teaches a method for encrypting data and transmitting it to an electronic device together with a decrypting key. The current prior art does not disclose a method or apparatus for proximity alarming or automatic login to an application. The current prior art does not disclose a method or apparatus for proximity alarming or automatic login to an application that runs onboard the mobile phone.

U.S. Pat. No. 7,069,001 by Rupp et al. titled Method for supporting cashless payment teaches a method for authorizing payment transactions using a mobile phone. Rupp does not teach using an electronic device together with the mobile phone.

U.S. Pat. No. 7,106,171 by Burgess et al. titled Keyless command system for vehicles and other applications teaches a wireless remote-control transmitter with keypad for entering an identification code so that only an authorized operator can use the device. The described system does not provide automatic locking and unlocking for vehicles based on Bluetooth proximity.

Thus, a need exists for systems for monitoring mobile phones and for providing automatic login functionality to applications, automatic screen unlocking functionality, and automatic user authentication for transaction processing. Such systems should provide an alarm to users upon detecting that a phone is not within a desired proximity, wherein the alarm is appropriate to the circumstances. Further, there is also a need for more automatic login to applications and services while reducing the risk of loss and unauthorized access, and to make such systems ubiquitous as standard accessories.

Thus, there is a need for a system that allows for a single application to be compatibly used with any operating system or platform. More particularly, there is a need for an engine, system and method to provide normalization for applications, and access to, sending of, and receipt of content developed, for use with computers, smart mobiles and other electronic devices and the various operating systems resident thereon.

### SUMMARY OF THE INVENTION

The present invention provides an engine, system and method for providing a method of locating a mobile device and reporting on other devices proximately located thereto.

### BRIEF DESCRIPTION OF THE DRAWINGS

The accompanying drawings are included to provide a further understanding of the disclosed embodiments. In the drawings:

FIG. 1 is a block diagram of an exemplary computing system for use in accordance with herein described systems and methods;

FIG. 2 is a block diagram showing an exemplary networked computing environment for use in accordance with herein described systems and methods;

FIG. 3 is an illustration showing an exemplary communication environment in accordance with the herein described systems and methods;

FIG. 4 is an illustration showing an exemplary communication environment in accordance with the herein described systems and methods;

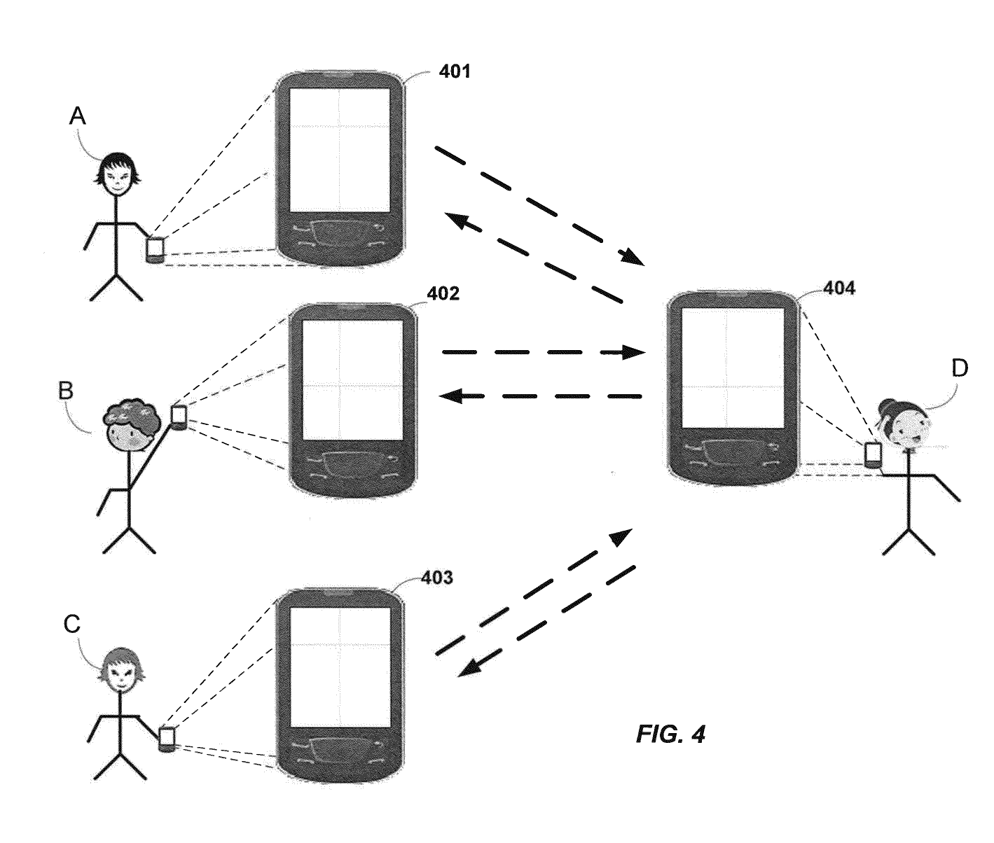

FIG. 5 is a block diagram illustrating exemplary communication steps in accordance with the herein described systems and methods; and

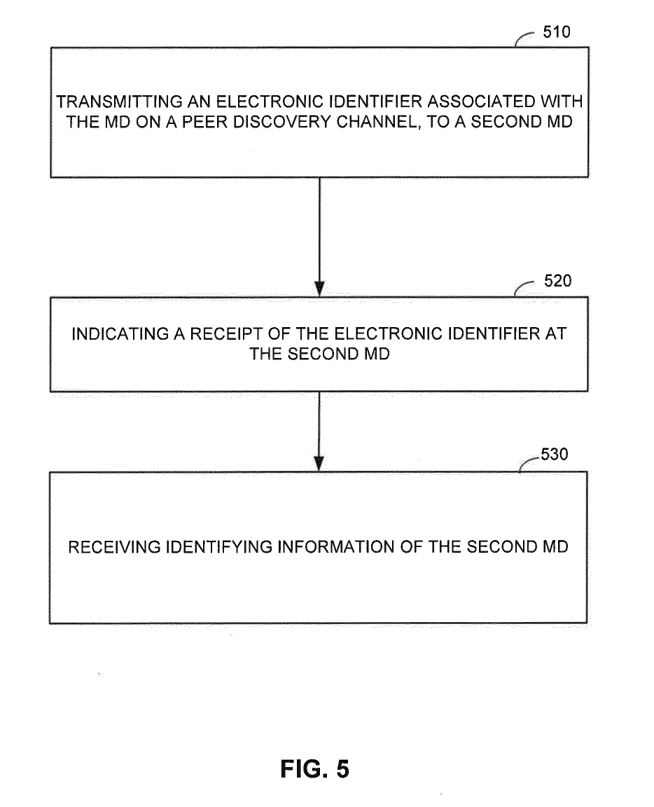

FIG. 6 is a block diagram illustrating exemplary communication steps in accordance with the herein described systems and methods.

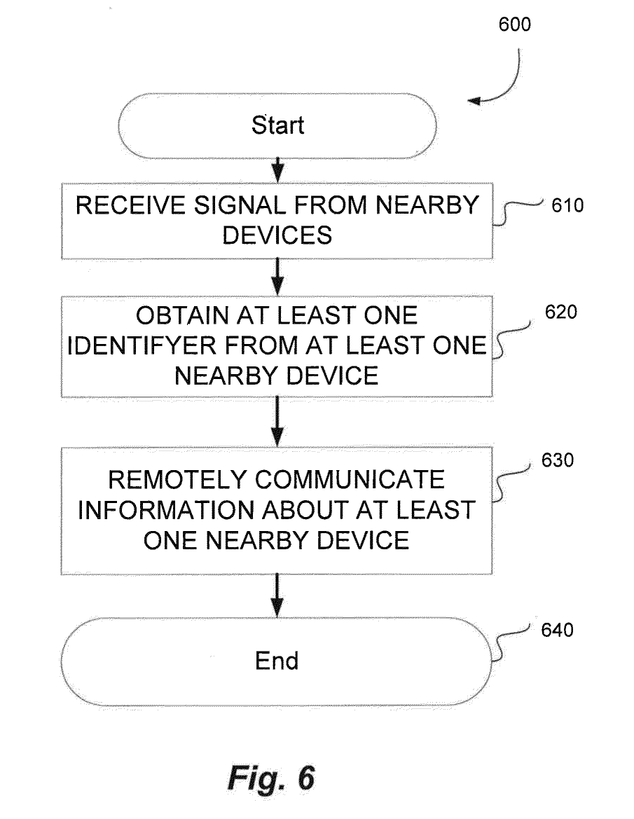

### DETAILED DESCRIPTION

A computer-implemented platform and methods of use are disclosed that provide networked access to a plurality of types of digital content, including but not limited to video, audio, and document content, and that track and deliver the accessed content, such as via one or more applications, or “apps.” Described embodiments are intended to be exemplary and not limiting. As such, it is contemplated that the herein described systems and methods can be adapted to provide many types of users with access and delivery of many types of domain data, and can be extended to provide enhancements and/or additions to the exemplary services described. The invention is intended to include all such extensions. Reference will now be made in detail to various exemplary and illustrative embodiments of the present invention.

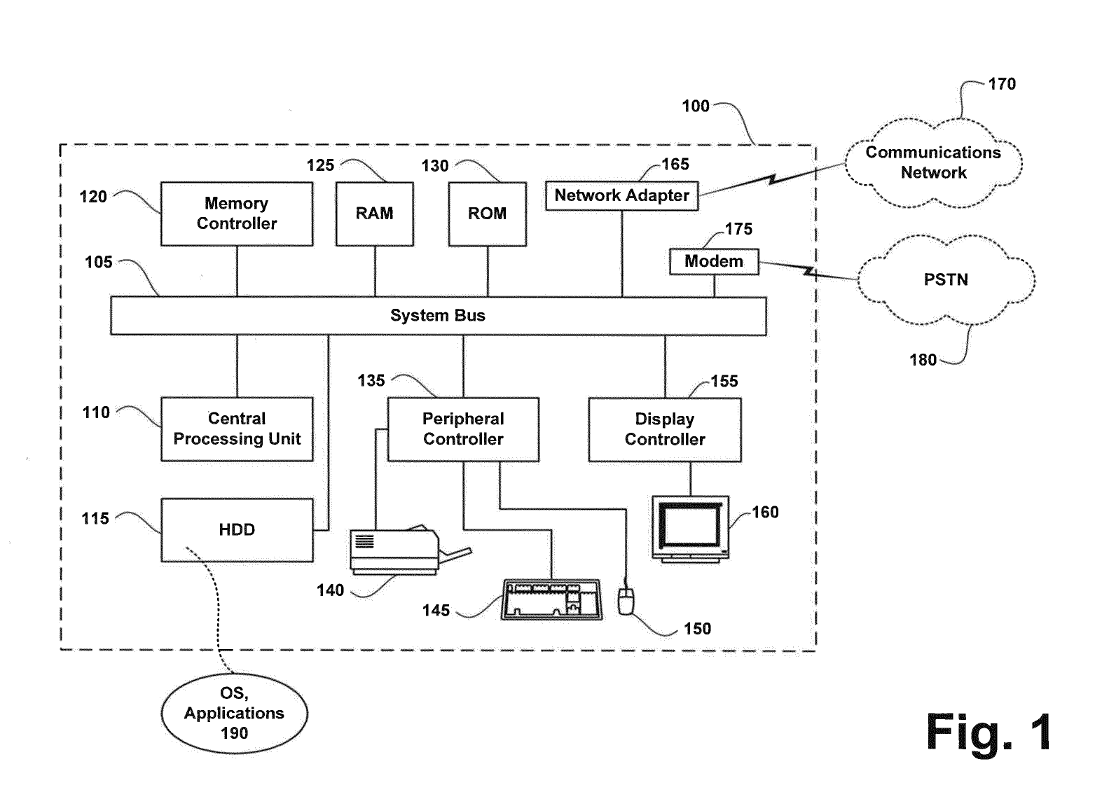

FIG. 1 depicts an exemplary computing system 100 that can be used in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, mobile devices, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output generated by computing system 100. Such visual output may include text, graphics, animated graphics, and/or video, for example. Display 160 may be implemented with a CRT-based video display, an LCD-based display, gas plasma-based display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet, and hence which may provide or include tracking of and access to the domain data discussed herein. Communications network 170 may provide user access to computing system 100 with means of communicating and transferring software and information electronically, and may be coupled directly to computing system 100, or indirectly to computing system 100, such as via PSTN or cellular network 180. For example, users may communicate with computing system 100 using communication means such as email, direct data connection, virtual private network (VPN), Skype or other online video conferencing services, or the like. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

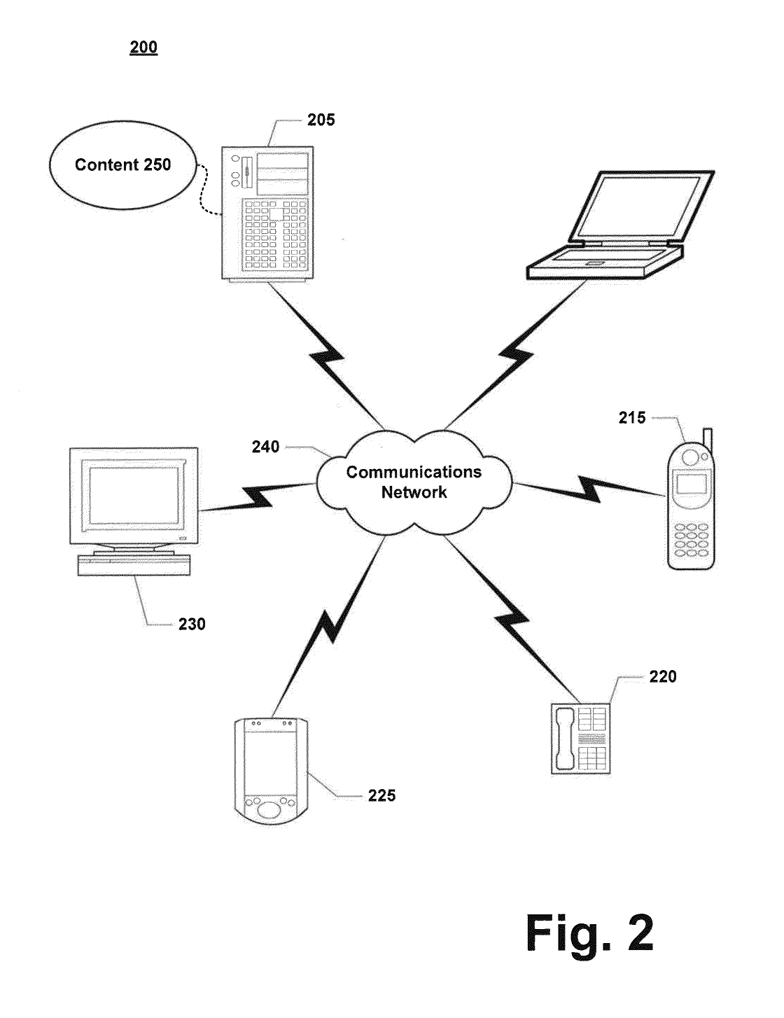

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or independently developed applications, the like, to interact with server 205.

The server 205 may thus deliver applications specifically designed for mobile client devices, such as, for example, client device 225. A client device 225 may be any mobile telephone, PDA, tablet or smart phone and may have any device compatible operating system. Such operating systems may include, for example, Symbian, RIM Blackberry OS, Android, Apple iOS, Windows Phone, Palm webOS, Maemo, bada, MeeGo, Brew OS, and Linux for smartphones and tablets. Although many mobile operating systems may be programmed in C++, some may be programmed in Java and .NET, for example. Some operating systems may or may not allow for the use of a proxy server and some may or may not have on-device encryption. Of course, because many of the aforementioned operating systems are proprietary, in prior art embodiments server 205 delivered to client device 225 only those applications and that content applicable to the operating system and platform communication relevant to that client device 225 type.

JavaScript Serialized Object Notation (JSON), a lightweight, text-based, language-independent data-interchange format, is based on a subset of the JavaScript Programming Language, Standard ECMA-262, 3.sup.rd Edition, dated December 1999. JSON syntax is a text format defined with a collection of name/value pairs and an ordered list of values. JSON is very useful for sending structured data over wire (e.g., the Internet) that is lightweight and easy to parse. It is language and platform independent, but uses conventions that are familiar to C-family programming conventions. The JSON language is thus compatible with a great many operating systems (a list of such systems is available at www.json.org).

The techniques described herein may be used for various wireless communication networks, such as CDMA, TDMA, FDMA, OFDMA, SC-FDMA, and other wireless networks. The terms “network” and “system” are often used interchangeably herein. By way of example, a CDMA network may implement a radio technology such as Universal Terrestrial Radio Access (UTRA), cdma2000, and the like. For example, an OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDM®, and the like. UTRA and E-UTRA are part of Universal Mobile Telecommunication System (UMTS). UTRA, E-UTRA, UMTS, as well as long term evolution (LTE) and other cellular techniques, are described in documents from an organization named “3rd Generation Partnership Project” (3GPP) and “3rd Generation Partnership Project 2” (3GPP2).

“WiFi” stands for “Wireless Fidelity.” WiFi is typically deployed as a wireless local area network (WLAN) that may extend home and business networks to wireless medium. As referenced, the IEEE 802.11 standard defines WiFi communications as between devices, and as between devices and access points. WiFi typically provides aggregate user data speeds from 2 Mbps (for 802.11b) to approximately 150 Mbps (for 802.11n). Typical speeds for WiFi are around 15 Mbps, and latency (i.e., packet delay) averages around 10 ms with no load. WiFi may link devices, and/or devices and access points, over distances from a few feet to several miles. By way of contrast, LTE, as mentioned above, typically provides WAN connectivity that may stretch for much greater distances, but is typically not preferred for LAN communications. Of note, the techniques described herein may be used for the wireless networks and radio technologies mentioned above, as well as for other wireless networks and radio technologies.

WiFi networks, herein also referred to as IEEE 802.11 wireless networks, may operate in two modes: infrastructure mode and ad-hoc mode. In infrastructure mode, a device connects to an access point (AP) [[EITHER USE THIS ABBREVIATION CONSISTENTLY, OR TAKE THE FOREGOING ABBREVIATION OUT]] that serves as a hub for connecting wireless devices to the network infrastructure, including, for example, connecting wireless devices to Internet access. Infrastructure mode thus uses a client-server architecture to provide connectivity to the other wireless devices. In contrast to the client-server architecture of infrastructure mode, in ad-hoc mode wireless devices have direct connections to each other in a peer-to-peer architecture.

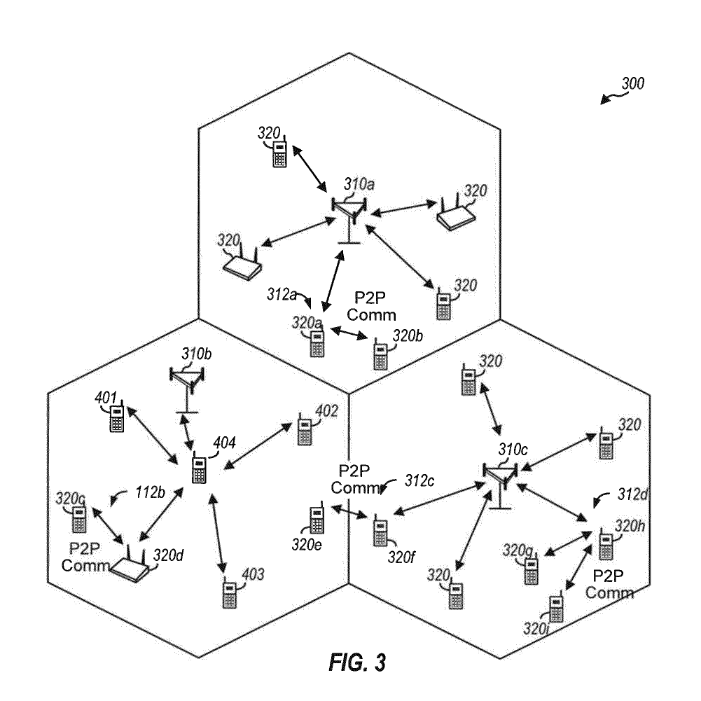

Referring now to FIG. 3, wireless network technologies may include both the afore-discussed WANs, and various types of WLANs. WLAN 100 may be used to interconnect nearby devices by employing widely used networking protocols, such as using the IEEE 802.11 wireless protocol family.

In one aspect, WLAN 100 operating in infrastructure mode may comprise various devices 320x, 320y, 320z, and an access point 302 serves a coverage area forming Wi-Fi cell 310a. An access point, as used herein, is a station that supports communication for wireless devices associated with that access point. An access point may also be referred to as a WiFi base station. In general, a WLAN may include any number of access points. Each access point may be identified by an access point identity (APID), which may be a globally unique Medium Access Control (MAC) address (i.e., an address the provides a unique identifier in the MAC protocol layer) that is included in frames transmitted by the access point 302. For example, the MAC address may correspond to an Internet Protocol (IP) address, or the like. Access point 302 may directly or indirectly couple to a network server 330 that may perform various functions. The network server 330 may be a single network entity or a collection of network entities.

A wireless device, or “device,” refers herein to a station that can communicate with another station via a wireless medium. A device may be stationary or mobile, and may also be referred to as a mobile station, a user equipment, a subscriber station, etc. A device may be a cellular phone, a personal digital assistant (PDA), a handheld device, a wireless device, a laptop computer, a wireless modem, a cordless phone, a telemetry device, a tracking device, etc. A device, and/or an access point, may also receive signals for satellites, which may be part of the United States Global Positioning System (GPS), the European Galileo system, the Russian Glonass system, or some other satellite Positioning System (SPS). A device may measure signals for access point 302, for other devices, and/or signals from the aforementioned satellites. The measurements may be used to determine the location and/or the connectivity of the device, the other devices, and/or the access points.

In the description herein, WLAN communication refers to communication between a device and an access point, i.e., communication in the aforementioned infrastructure mode, such as for a call between the device and a remote entity, such as another device, via the access point. A WLAN link, and variants thereof, as used herein, thus refers to a communication link between a device and an access point.

In contrast, in ad hoc mode, also referred to herein as peer-to-peer (P2P) mode, one of the devices may provide some or all of the communication and communication management responsibilities of the access point 302 and/or of the network server 330. These responsibilities may include the periodic beaconing process, and the authentication of new members, by way of non-limiting example. Accordingly, P2P mode may be used to connect mobile devices together when there is no operating or present access point.

Thus, P2P mode, or P2P communication, as used herein, refers to direct communication between two or more devices, wherein the direct communication occurs without going through or need of an access point. A P2P link, or variants thereof, thus refers to a direct communication link between two or more devices engaged in P2P communication. Correspondingly, a WLAN device is a device that is interested or engaged in WLAN communication, and a P2P device (otherwise known as an enhanced device) is a device that is interested or engaged in P2P communication. A device, as used herein, may be a WLAN device, or an “enhanced” device. As used herein, an enhanced WiFi device may be one that provides enhanced capabilities, such as for improved communications, increased power consumption efficiencies, increased other efficiencies, or the like.

A P2P group refers to a group of two or more devices engaged in P2P communication. In one design, one device in the P2P group may be designated as a P2P server (or a P2P group owner), and each remaining device in the P2P group may be designated as a P2P client. The P2P server may perform certain management functions, such as exchanging signaling with an access point of the WLAN, coordinating data transmission between the P2P server and the P2P client(s), and the like.

More particularly, IEEE 802.11 defines a set of standards to carry out the WLAN communication that may occur in FIG. 1 as between devices 320x, 320y, 320z, and as between devices 320x, 320y, 320z and access point 302, at the physical (PHY) and MAC protocol layers. The Wi-Fi Alliance is a trade group that certifies wireless devices based on adherence to the IEEE 802.11 standards, and that endeavors to guarantee interoperability between different wireless devices. More particularly, at the PHY layer, IEEE 802.11 defines and the WiFi Alliance endeavors to enforce two sublayers, namely the Physical Layer Convergence Procedure (PLCP), and the Physical Medium Dependent sublayer (PMD).

The PLCP sublayer defines specifications for converting MAC Layer Protocol Data Units (MPDUs) into a suitable frame format. This enables sending and receiving of user data and management information between two or more devices using the underlying PMD sublayer. The PMD sublayer defines specifications for methods of transmitting and receiving user data over a wireless medium between two or more devices and characteristics of the user data.

Technology for locating wireless devices (e.g., cell phones) with high accuracy began to be widely deployed in response to the United States Federal Communications Commission (FCC) Enhanced 9-1-1 Phase II mandate. Wireless location technologies include both network-based and handset based technologies. The network-based high accuracy technologies use the uplink (mobile-to-base station) radio signaling from the handset with Time-of-Arrival (TOA), Time-Difference-of-Arrival (TDOA), and/or Angle of Arrival (AoA) techniques to locate a mobile device. High accuracy location technologies may include the use of a timing beacon systems such as a Global Navigation Satellite System (GNSS), the prime example being the NAVSTAR Global Positioning System (GPS). Use of GNSS signals and signaling from the wireless communications network allow for Assisted GNSS (A-GNSS) which lowers the time needed to generate a position fix over conventional GPS and can increase receiver sensitivity.

Medium accuracy location technologies are sometimes used for localization of transmitters either as a fallback method or in conjunction with a high accuracy localization technique. These techniques include the network-based techniques of cell-ID localization and may include the addition of timing or power ranging Signal-Strength-Measurement (SSM) with calibrated RF fingerprinting (a pattern matching technique). The handset-based medium accuracy technologies include downlink radio signal techniques such as Enhanced Observed Time Difference (E-OTD), Advanced Forward Link Trilateration (AFLT), and Observed Time Difference of Arrival (OTDOA).

Hybridization of location technologies may also be used. Various combinations of U-TDOA, AoA, AFLT, A-GPS, TOA, SSM, and OTDOA have been successfully fielded while other combinations of the high or high/medium accuracy handset and network location techniques have been proposed.

Passive Location using network-based wireless location techniques relies on the monitoring of the radio air interface or WCN links and waiting for the mobile device to execute a network transaction either on the control channel or traffic channel. These network transactions include periodic re-registration, as well as ad hoc events such as call or data connection related events (initiation, termination, handover) and roaming events such as location updating.

Active Location using network-based wireless location techniques relies on cooperation or co-opting of the wireless location system. Cooperative arrangements include polling or auditing via system messaging examples of which include Identity Request, Any_Time_Interrogation (ATI) (as part of the Mobile Terminated Location Request Procedure), Null SMS pinging or simply calling or messaging the mobile in question. Co-opting of the WCN includes use of a control-channel only IMSI catcher base station where idle mobiles devices are momentarily re-registered, a honey-pot base station where both on-call (in session) mobile devices are captured, interrogated and identified, or placing small WCN cells in specific areas with localized paging areas (location areas) to force mobiles to re-register.

US patent application publication 20050280546 by Ganley et al. titled Proximity aware personal alert system discloses two mobile transceivers that are linked through a Bluetooth link. The Bluetooth enabled RF link between the first and second mobile transceiver units forms a monitoring piconet. The second mobile transceiver unit provides an alarm indication when the first mobile transceiver unit moves beyond a distance of approximately ten meters from the second mobile transceiver unit. The second device repeatedly pages the first device, and waits for a response. If a response is not received, an alarm is issued. This system does not use sleep modes effectively. It uses paging which consumes 40 mA, a rate that would inconvenience the user by requiring an expensive and/or heavy battery or frequent recharging. The system of the current invention relies on HFP or SPP link, and alerts on link drop.

When Bluetooth pairing is being set up, the following usually happens:

Device A (such as a handheld) searches for other Bluetooth enabled devices in the area. How does A find these devices? The devices that are found all have a setting that makes them discoverable when other Bluetooth devices search. It's like raising your hand in a classroom: the discoverable devices are announcing their willingness to communicate with other Bluetooth devices. By contrast, many Bluetooth devices can toggle their discoverability settings off. When discoverability is off, the device will not appear when other devices search for it. Undiscoverable devices can still communicate with other Bluetooth devices, but they must initiate all the communications themselves.

A detects Device B (such as a second handheld that's discoverable). During the discovery process, the discoverable devices usually broadcast what they are (such as a printer, a PC, a mobile phone, a handheld, etc.), and their Bluetooth Device Name (such as “Tom's Laptop” or “laserjet5003”). Depending on the device, you may be able to change the Device Name to something more specific. If there are 10 Bluetooth laptops and 5 Bluetooth mobile phones in range, and they are all discoverable, this can come in handy when selecting a specific device.

A asks B to send a Passkey or PIN A passkey (or PIN) is a simple code shared by both devices to prove that both users agree to be part of the trusted pair. With devices that have a user interface, such as handhelds, mobile phones, and PCs, a participant must enter the passkey on the device. With other types of devices, such as printers and hands-free headsets, there is no interface for changing the passkey on the device, so the passkey is always the same (hard coded). A passkey used on most Bluetooth headsets is “0000”. The passkeys from both parties must match.

A sends the passkey to B Once you've entered the passkey on A, it sends that passkey to B for comparison. If B is an advanced device that needs the user to enter the same passkey, it will ask for the passkey. If not, it will simply use its standard, unchanging passkey.

B sends passkey back to A If all goes well, and B's passkey is the same entered by A, a trusted pair is formed. This happens automatically when the passkeys agree. Once a trusted pair is developed, communication between the two devices should be relatively seamless, and shouldn't require the standard authentication process that occurs between two devices who are strangers. Embodiments of the present inventions take advantage of the reduced power requirements of certain Bluetooth modes following pairing of two Bluetooth enabled devices.

A method for authorizing Near Field communication (NFC) may comprise the steps of establishing a two-way secure wireless connection between a first mobile device having an NFC function and a second mobile device, wherein said second mobile device comprises a short wireless transceiver, wherein said second mobile device has a size smaller than 20 CM3, wherein said second mobile device can pair with a compatible apparatus within proximity, wherein upon pairing with said first mobile device, said second mobile device changes mode to a non-discoverable mode, wherein said second mobile device can store user data, which may include a digital key, for example and wherein upon receiving a request for authenticating an NFC payment transaction, said first mobile device will send a request to said second mobile device, wherein said first mobile device will authorize the NFC communication if it receives a response from said second mobile device that enables said first mobile device to authorize the NFC communication.

An embodiment of the present invention includes a unitary mobile apparatus, comprising: a flash storage means, a short wireless transceiver, an attachment means selected from the group consisting of a key chain, a ring, a bracelet, a VELCRO and a clip; wherein said unitary mobile apparatus has a size smaller than 20 CM3, wherein said unitary mobile apparatus can pair with a first mobile device within proximity, wherein said unitary mobile apparatus can establish a secure two-way wireless connection with a first mobile device, wherein upon pairing with a first mobile device, said unitary mobile apparatus can switch to a non-discoverable mode, wherein said unitary mobile apparatus can send data wirelessly to said first mobile device, a data port for connecting said unitary mobile apparatus to a third device and for flashing or writing or downloading user data onboard said unitary mobile apparatus, whereby said user data is selected from the group consisting of a a digital key, an encryption key; wherein upon receipt of a message from said first mobile device for authorizing an NFC communication, said unitary mobile apparatus can send a reply to said first mobile device, said unitary mobile apparatus can authorize or deny said NFC communication.

The present invention may allow a first device to query and at least one second device as to the location of the second device and the number and identification of any other device proximate to the second device. By way of example, a first device may be a PC within a parental home having software which may allow communication through at least one communications network with the at least one second device. After a query, the at least one second device may report back to the first device it's location and may provide a listing and or identification of other devices proximate to the second device. For example, the second device may report back that there are two other devices proximate to the second device. The identification of the two proximate devices may include the phone number of the devices and or the name associated with that identifier contained with in the second device.

For example, if the second device is proximate to a known device, such as a device held by a friend, the reporting back to the first device may include the name provided to that device by the second device's stored contact information, such as through a stored contacts list. If no identifier may be reasonably obtained by the at least one second device, the reported back identifier may simply be an unknown number or other identifier of a proximate mobile device. By way of nonlimiting example only, parents may access a home computer to query a child cell phone. Such a query may indicate that the child's cell phone is not in the location expected by the parents. The query may also indicate that a large number, such as 30, other cellular devices are proximate to the child's device. Such a large number of approximate devices may indicate that the child is in a place such as a mall, sporting event, or add a party, for example.

Of course, as would be understood by those skilled in the art, the location information provided by the query may allow an indication as to the forearm or venue for which the child is present. For example, a map may locate the Child's device at a mall or at an athletic field at the child's school. Further, and in conjunction with the contact list residence on the child cell phone device, the parents may be alerted to identity of those mobile device holders proximate to the child. Thus, the parent they decide whether or not the child is in the approved location and or is associated with those whom the parents have approved the child to associate. Proximity may also be controlled by the at least one first device to better limit the number of devices seen. For example, the range of identifying devices by the at least one second device may be limited to thirty (60) feet to approximate a free-standing home. Similarly, to eliminate “noise” from the second device, the proximity may be limited to ten (10) feet, for example, such as in a study environment in a library.

Similarly, such functionality may allow for the rapid locating of a stolen or otherwise lost device. For example, although the location detection feature of the present invention allows for the identification and addressing of a lost phone, for example, a phone is a very small device relative to the address locations identified by the present invention. This may cause a classic “needle in a haystack onion” problem with regards to finding a lost or stolen cell phone. Utilizing proximity of secondary devices, the present invention may allow for a more defined triangulation of the position of a lost or stolen cell phone. By way of non-limiting example only, if the lost or stolen device is at a particular address such as for example a house, the investigating user may not be able to determine which room with in the house the device lies. Once a user is logged in to the present invention through a first device, the use of one or more other devices including the first device may allow for the location of the last device to be pinpointed using the proximity to the other devices as they move around the house.

Those of skill in the art will appreciate that the herein described systems and methods are susceptible to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A method for identifying proximate remote devices, comprising:
receiving from a first device a request for the identification of at least one third device proximate to a second device;
searching of the proximate area by the second device for at least the one third device;
receiving at the second device identifying information of the at least one third device;
comparing the received indentifying information with at least one identification record present on the at least one second device wherein any matched record is at least partially combined with the received indentifying information; and
sending to the first device the identifying information by the at least one second device.
